(19) United States
(12) Patent Application Publication
(10) Pub. No.: US 2025/0140469 A1
(43) Pub. Date: May 1, 2025

(54) COIL DEVICE

(71) Applicant: TDK CORPORATION, Tokyo (JP)

(72) Inventors: Riku UMEKI, Tokyo (JP); Kiyofumi FUJIWARA, Tokyo (JP); Satoshi SUGIMOTO, Tokyo (JP)

(73) Assignee: TDK CORPORATION, Tokyo (JP)

(21) Appl. No.: 18/918,469

(22) Filed: Oct. 17, 2024

(30) Foreign Application Priority Data
Oct. 26, 2023 (JP) 2023-183953

(51) Int. Cl. H01F 27/28; H01F 27/24

(52) U.S. Cl. CPC H01F 27/2823; H01F 27/24

(57) ABSTRACT

To provide a coil device capable of preventing a short-circuit failure during mounting. A coil device 1 includes a core having a mounting surface, a first conductor formed of a wire, and a second conductor formed of a conductor plate. The first conductor includes a first body portion extending along the mounting surface inside the core. The second conductor includes a second body portion extending along the mounting surface inside the core and facing the first body portion. In a direction in which the first body portion and the second body portion face each other, the first body portion is positioned on one side of the core, and the first body portion and the second body portion are offset to the one side of the core on which the first body portion is positioned.

### BACKGROUND OF THE INVENTION

### Field of the Invention

The present disclosure relates to a coil device that can be used as, for example, a coupling inductor.

### Description of the Related Art

For example, in a power supply circuit of a server, a coil device called a coupling inductor may be used in order to improve a response speed of a voltage regulator or to reduce the number of components in the power supply circuit. As a coil device of this type, Japanese Patent Laid-Open No. 2009-117676 (Patent Literature 1) discloses a coil device including a core, a first conductor, and a second conductor. The first conductor and the second conductor are formed of a conductor plate obtained by bending a copper plate into a predetermined shape. The first conductor and the second conductor face each other at a predetermined interval inside the core and are magnetically coupled to each other.

In recent years, the distance between conductors tends to become narrower with the progress of downsizng of coil devices. For example, if an attempt is made to further downsize the coil device according to Patent Literature 1, the first conductor and the second conductor will be brought closer to each other, and the distance between the first conductor and the second conductor will be narrowed. Therefore, when the coil device is mounted on a mounting substrate, solder or the like may adhere across the first conductor and the second conductor, which may cause a short-circuit failure between the first conductor and the second conductor.
Patent Document 1: Japanese Patent Laid-Open No. 2009-117676

### SUMMARY OF THE INVENTION

The present disclosure is made in view of such circumstances, and an object thereof is to provide a coil device capable of preventing a short-circuit failure during mounting.

In order to achieve the above object, a coil device according to the present disclosure includes:
a core having a mounting surface;
a first conductor formed of a wire; and
a second conductor formed of a conductor plate, in which
the first conductor includes a first body portion extending along the mounting surface inside the core,
the second conductor includes a second body portion extending along the mounting surface inside the core and facing the first body portion, and
in a direction in which the first body portion and the second body portion face each other, the first body portion is positioned on one side of the core, and the first body portion and the second body portion are offset to the one side of the core on which the first body portion is positioned.

In the coil device according to the present disclosure, the first conductor is formed of a wire, and the second conductor is formed of a conductor plate. Therefore, for the first conductor, there is no need to perform processes such as punching or bending the conductor plate. Accordingly, the coil device can be easily manufactured and the cost can be reduced.

In the direction in which the first body portion and the second body portion face each other, the first body portion and the second body portion are offset to the one side of the core on which the first body portion is positioned. Therefore, a space corresponding to an offset amount of the first body portion and the second body portion is formed on the other side of the core. By using this space to dispose a part (for example, a mounting portion) of the second conductor so as to be separated from the first conductor, occurrence of a short-circuit failure can be prevented between the first conductor and the second conductor.

On the other side of the core, a volume of the core increases according to the offset amount of the first body portion and the second body portion. Therefore, an inductance property and/or a DC superimposition property of the coil device are improved.

The first body portion and the second body portion may be positioned on one side of the core with respect to a center of the core in the direction in which the first body portion and the second body portion face each other. In this case, at least a space for disposing a part (for example, the mounting portion) of the second conductor is formed on the other side of the core with respect to the center of the core. By disposing the part (for example, the mounting portion) of the second conductor in this space so as to be separated from the first conductor, occurrence of the short-circuit failure can be effectively prevented between the first conductor and the second conductor.

The first conductor includes a first mounting portion exposed from the core, the second conductor includes a second mounting portion exposed from the core, and the second mounting portion extends to the other side of the core so as to be separated from the first mounting portion. In this case, the second mounting portion is disposed at a position separated from the first mounting portion. Therefore, when the coil device is mounted on a mounting substrate, solder or the like is less likely to adhere across the first mounting portion and the second mounting portion. Accordingly, the occurrence of the short-circuit failure can be effectively prevented between the first conductor and the second conductor.

The first mounting portion and the second mounting portion may be disposed inside an outer edge of the core as viewed in a direction perpendicular to the mounting surface. Such a configuration can be obtained by, for example, downsizing the first mounting portion and the second mounting portion or increasing the volume of the core. In the former case, the coil device can be downsized. In the latter case, the inductance property of the coil device can be improved.

The core has a side surface perpendicular to the mounting surface and a recess formed in the side surface, and the first mounting portion and the second mounting portion are accommodated in the recess. In this case, the first mounting portion and the second mounting portion are less likely to be exposed from the outer edge of the core as viewed in the direction perpendicular to the mounting surface. Therefore, the coil device can be downsized.

A first width of the first body portion may be different from a second width of the second body portion in the direction in which the first body portion and the second body portion face each other. In this case, magnetic coupling between the first body portion and the second body portion can be adjusted according to the difference between the first width and the second width. A large current can be caused to flow through the conductor having a larger one of the first width and the second width.

The first width may be larger than the second width. In this case, a large current can be caused to flow through the first conductor.

A height position of the first body portion from the mounting surface may be different from a height position of the second body portion from the mounting surface. In this case, the magnetic coupling between the first body portion and the second body portion can be adjusted according to the difference between the height position of the first body portion from the mounting surface and the height position of the second body portion from the mounting surface.

The first body portion may be in contact with the second body portion. In this case, the magnetic coupling between the first body portion and the second body portion can be enhanced.

The second conductor may include a plating layer formed on at least a part of the second conductor. For example, by forming the plating layer on an end (the mounting portion) in an extending direction of the second conductor, the second conductor can be easily connected to the mounting substrate by solder or the like.

The first conductor may include an insulating coating layer formed on at least a part of the first conductor. In this case, the first conductor can be insulated from the second conductor by the insulating coating layer. Therefore, the short-circuit failure between the first conductor and the second conductor can be effectively prevented.

### BRIEF DESCRIPTION OF THE DRAWINGS

FIG. 1 is a perspective view of a coil device according to an embodiment of the present disclosure;

FIG. 2 is a perspective view of a first core illustrated in FIG. 1;

FIG. 3 is an exploded perspective view of the coil device illustrated in FIG. 1;

FIG. 4 is a perspective view of a first conductor and a second conductor illustrated in FIG. 1;

FIG. 5 is a cross-sectional view of the coil device illustrated in FIG. 1 taken along a line V-V; and

FIG. 6 is a plan view of the first core to which the first conductor and the second conductor illustrated in FIG. 3 are attached.

### DETAILED DESCRIPTION OF THE PREFERRED EMBODIMENTS

Hereinafter, an embodiment of the present disclosure will be described with reference to the drawings. The illustrated contents are merely schematically and exemplarily illustrated for the purpose of understanding the present disclosure, and the appearance, the dimensional ratio, and the like may be different from those of an actual object. The present disclosure is not limited to the following embodiment.

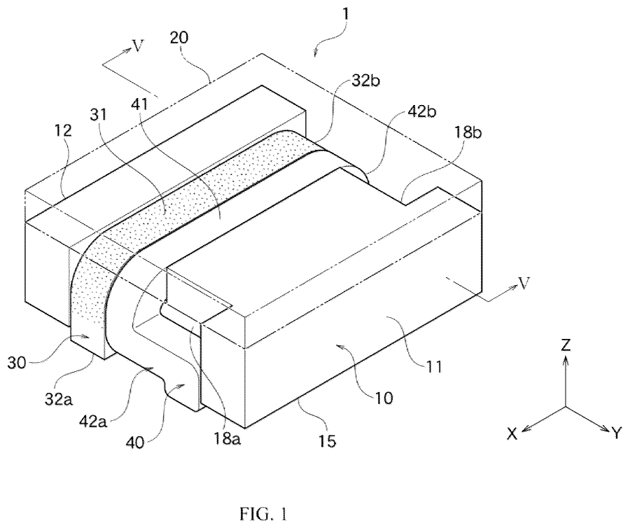

A coil device 1 illustrated in FIG. 1 functions as a coupling inductor, and is provided, for example, in a power supply circuit of a server. The coil device 1 includes a first core 10, a second core 20, a first conductor 30, and a second conductor 40. A core according to the present embodiment is constituted by two cores of the first core 10 and the second core 20, but the core may be constituted by one core, or three or more cores.

In FIGS. 1 to 6, an X axis is an axis along an axial direction of the first conductor 30 (a first body portion 31) or the second conductor 40 (a second body portion 41). A Y axis is an axis along a direction in which the first conductor 30 and the second conductor 40 face each other. A Z axis is an axis perpendicular to the X axis and the Y axis. The X axis, the Y axis, and the Z axis are perpendicular to each other. Hereinafter, for each of the X axis, the Y axis, and the Z axis, a direction away from a center of the coil device 1 is referred to as “outside”, and a direction approaching the center of the coil device 1 is referred to as “inside”. A positive direction side of the Z axis is referred to as “upper side”, and a negative direction side of the Z axis is referred to as “lower side”. However, the upper side in a Z-axis direction does not necessarily coincide with an upper side in a vertical direction. The lower side in the Z-axis direction does not necessarily coincide with a lower side in the vertical direction.

A width of the coil device 1 in an X-axis direction is not particularly limited, and is, for example, 3.0 mm to 20.0 mm. A width of the coil device 1 in a Y-axis direction is not particularly limited, and is, for example, 3.0 mm to 10.0 mm. A thickness of the coil device 1 in the Z-axis direction is not particularly limited, and is 3.0 mm to 10.0 mm.

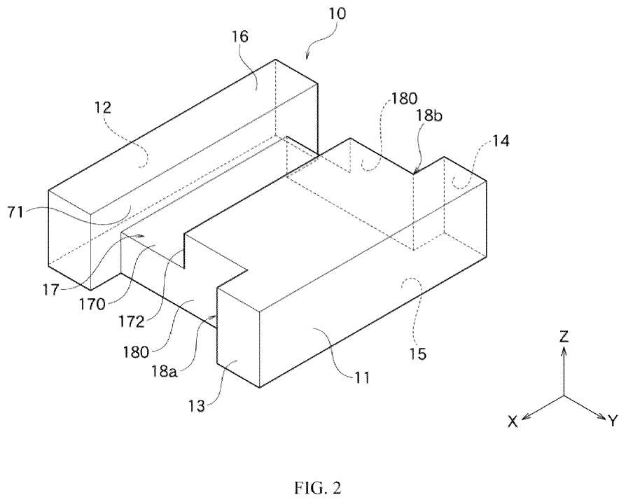

As illustrated in FIG. 2, the first core 10 has a first side surface 11, a second side surface 12, a third side surface 13, a fourth side surface 14, a mounting surface 15, and a mounting facing surface 16. The first side surface 11 and the second side surface 12 have the same shape and are positioned on opposite sides along the Y axis. The shape of the first side surface 11 and the second side surface 12 is a rectangle, but may be a square or another polygon. The third side surface 13 and the fourth side surface 14 have the same shape and are positioned on opposite sides along the X axis. The mounting surface 15 and the mounting facing surface 16 are positioned on opposite sides along the Z axis. The first core 10 has a flat shape in which a width in the Z-axis direction is smaller than a width in the X-axis direction and a width in the Y-axis direction.

The first core 10 has a groove 17 formed in the mounting facing surface 16. The groove 17 is positioned on one side (a second side surface 12 side) of the first core 10 in the Y-axis direction and extends along the X axis. The groove 17 has a bottom surface 170 and inner walls 171 and 172. The bottom surface 170 is a flat surface parallel to the mounting surface 15. The inner walls 171 and 172 are surfaces perpendicular to the bottom surface 170. The inner wall 171 and the inner wall 172 face each other along the Y axis.

In the present embodiment, the term “parallel” is not limited to strictly parallel. The term “perpendicular” is not limited to strictly perpendicular.

The first core 10 has a recess 18a formed in the third side surface 13 and a recess 18b formed in the fourth side surface 14. Both the third side surface 13 and the fourth side surface 14 are perpendicular to the mounting surface 15. The recess 18a is recessed inward from the third side surface 13 along the X axis. The recess 18b is recessed inward from the fourth side surface 14 along the X axis. The recesses 18a and 18b have lateral bottom surfaces 180. The lateral bottom surface 180 is a flat surface and is perpendicular to the mounting surface 15. The groove 17 extends along the X axis from the lateral bottom surface 180 of the recess 18a to the lateral bottom surface 180 of the recess 18b.

The first core 10 is made of a composite material containing a magnetic material and a resin. The first core 10 is formed by, for example, powder compaction, injection molding, or scraping. The magnetic material for the first core 10 is not particularly limited, and is, for example, ferrite (Ni—Zn ferrite, Mn—Zn ferrite, or the like) or a metal magnetic material. The resin for the first core 10 is not particularly limited, and is, for example, an epoxy resin or a phenol resin.

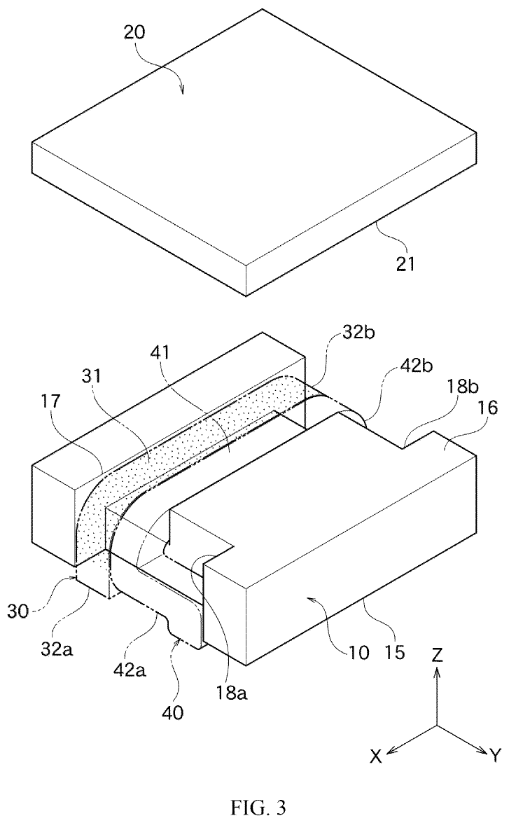

As illustrated in FIG. 3, the second core 20 has a rectangular parallelepiped shape. The second core 20 has a flat shape in which a width in the Z-axis direction is smaller than a width in the X-axis direction and a width in the Y-axis direction. The second core 20 is formed by, for example, powder compaction, injection molding, or scraping. The second core 20 has a contact surface 21 that contacts the mounting facing surface 16 of the first core 10. The second core 20 (the contact surface 21) is bonded to the first core 10 (the mounting facing surface 16) by, for example, an adhesive.

A material for the second core 20 may be the same as or different from the material for the first core 10. A relative permeability of the second core 20 may be the same as or different from a relative permeability of the first core 10.

The width of the second core 20 in the X-axis direction is not particularly limited, and is equal to a maximum width of the first core 10 in the X-axis direction. The width of the second core 20 in the Y-axis direction is not particularly limited, and is equal to the width of the first core 10 in the Y-axis direction. The thickness of the second core 20 in the Z-axis direction is not particularly limited, and is thinner than the thickness of the first core 10 in the Z-axis direction.

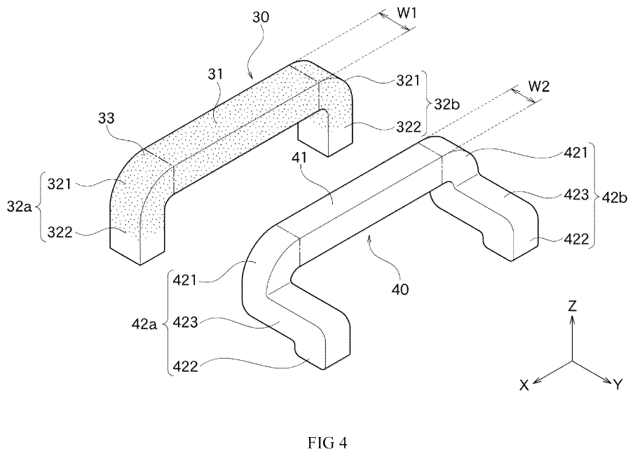

The first conductor 30 illustrated in FIG. 4 is formed of a wire (a rectangular wire in the present embodiment). The first conductor 30 has flexibility (rigidity lower than that of the second conductor 40) and deformable (bendable). The first conductor 30 is formed by bending a wire into a shape (a C-shape) illustrated in FIG. 4. The first conductor 30 is an insulated coated wire in which a conductive core wire such as a rectangular wire is coated with an insulating coating (an insulating coating layer) 33. More specifically, the first conductor 30 is a known winding wire such as a polyamide imide copper wire (AIW), a polyurethane copper wire (UEW), or a polyester copper wire (PEW). A material for the first conductor 30 is not particularly limited, and is, for example, copper, a copper alloy, silver, or nickel. The first conductor 30 may not include the coating 33.

The first conductor 30 is a primary coil, and the second conductor 40 is a secondary coil. However, the first conductor 30 may be a secondary coil, and the second conductor 40 may be a primary coil. The first conductor 30 and the second conductor 40 constitute a coupling coil magnetically coupled to each other.

As illustrated in FIG. 4, the first conductor 30 includes the first body portion 31 and first mounting portions 32a and 32b. The first body portion 31 is elongated along the X axis and extends linearly. A cross-sectional shape of the first body portion 31 is a rectangle, but may be a square, a trapezoid, another polygon, or another shape. A first width W1 of the first conductor 30 in the Y-axis direction is not particularly limited, and is 0.1 mm to 2.0 mm.

The first body portion 31 has an upper surface, a bottom surface, and two side surfaces. These surfaces are flat surfaces perpendicular to each other. The upper surface and the bottom surface are positioned on opposite sides along the Z axis and are parallel to each other. The two side surfaces are positioned on opposite sides along the Y axis and are parallel to each other. The upper surface and the bottom surface are parallel to an XY plane (the mounting surface 15 illustrated in FIG. 3), and the two side surfaces are perpendicular to the XY plane (the mounting surface 15 illustrated in FIG. 3).

At least one of the two side surfaces, the upper surface, and the bottom surface of the first body portion 31 may not be a flat surface, and may be, for example, an inclined surface, an uneven surface, a curved surface, or a bent surface. For example, the side surface of the first body portion 31 is perpendicular to the XY plane (that is, the mounting surface 15 illustrated in FIG. 3), but may be an inclined surface inclined at a predetermined angle (for example, 30° or more and less than) 90° with respect to the mounting surface 15.

The first mounting portion 32a is continuous with one end of the first body portion 31 in the axial direction, and the first mounting portion 32b is continuous with the other end of the first body portion 31 in the axial direction. In FIG. 4, a boundary between the first body portion 31 and the first mounting portion 32a and a boundary between the first body portion 31 and the first mounting portion 32b are indicated by one-dot chain lines. A shape of the first mounting portion 32a is the same as a shape of the first mounting portion 32b, but may be different.

The first mounting portions 32a and 32b each have a shape bent in an L-shape. The first mounting portions 32a and 32b are connected to a mounting substrate by solder, a conductive adhesive, or the like. Each of the first mounting portions 32a and 32b includes a curved portion 321 and a leg portion 322.

The curved portion 321 is continuous with the first body portion 31 and is curved in an L-shape (a C-shape) between the first body portion 31 and the leg portion 322. The leg portion 322 linearly extends along the Z axis. The leg portion 322 is orthogonal to the first body portion 31. A cross-sectional shape of the leg portion 322 is a rectangle, but may be a square, another polygon, or another shape.

The coating 33 covers the first body portion 31, the curved portion 321, and a part of the leg portion 322. The coating 33 is peeled off from a part of the leg portion 322 so that solder, a conductive adhesive, or the like is likely to adhere. However, the coating 33 may entirely cover the leg portion 322. The coating 33 entirely covers the first body portion 31, but may cover a part of the first body portion 31.

The second conductor 40 includes the second body portion 41 and second mounting portions 42a and 42b. The second body portion 41 is elongated along the X axis and extends linearly. The second body portion 41 is disposed in parallel with the first body portion 31. A cross-sectional shape of the second body portion 41 is a rectangle, but may be a square, a trapezoid, another polygon, or another shape. A second width W2 of the second conductor 40 in the Y-axis direction is not particularly limited, and is 0.1 mm to 2.0 mm.

The second conductor 40 is formed of a metal frame. The second conductor 40 is formed by, for example, machining (for example, punching, bending, cutting, pressing, sheet metal working, casting, or forging) a metal plate (a conductor plate) or a metal piece (a conductor piece) into the shape illustrated in FIG. 4. The second conductor 40 has higher rigidity than a general wire (a round wire, a rectangular wire, or the like). The rigidity of the second conductor 40 is higher than the rigidity of the first conductor 30. A material for the second conductor 40 is not particularly limited, and is, for example, copper, a copper alloy, silver, or nickel.

A plating film (a plating layer) is formed on at least a part of the second conductor 40. In the present embodiment, the plating film is formed on the entire second conductor 40, but the plating film may be formed only on a part (for example, the second mounting portions 42a and 42b) of the second conductor 40. The formation of the plating layer on the second mounting portions 42a and 42b improves solderability of the second mounting portions 42a and 42b. Therefore, the second conductor 40 can be easily connected to the mounting substrate by solder, a conductive adhesive, or the like. The plating film may be constituted by a single layer or a plurality of layers. The plating film is not particularly limited, and examples thereof include Cu plating, Ni plating, Sn plating, Ni—Sn plating, Cu—Ni—Sn plating, Ni—Au plating, and Au plating.

The second body portion 41 has an upper surface, a bottom surface, and two side surfaces. These surfaces are flat surfaces perpendicular to each other. The upper surface and the bottom surface are positioned on opposite sides along the Z axis and are parallel to each other. The two side surfaces are positioned on opposite sides along the Y axis and are parallel to each other. The upper surface and the bottom surface are parallel to an XY plane (the mounting surface 15 illustrated in FIG. 3), and the two side surfaces are perpendicular to the XY plane (the mounting surface 15 illustrated in FIG. 3).

At least one of the two side surfaces, the upper surface, and the bottom surface of the second body portion 41 may not be a flat surface, and may be, for example, an inclined surface, an uneven surface, a curved surface, or a bent surface. For example, the side surface of the second body portion 41 is perpendicular to the XY plane (that is, the mounting surface 15 in FIG. 3), but may be an inclined surface inclined at a predetermined angle (for example, 30° or more and less than) 90° with respect to the mounting surface 15.

In a direction (the Y-axis direction) in which the first body portion 31 and the second body portion 41 face each other, the first width W1 of the first body portion 31 is different from the second width W2 of the second body portion 41. Therefore, magnetic coupling between the first body portion 31 and the second body portion 41 can be adjusted according to the difference between the first width W1 and the second width W2. A large current can be caused to flow through the conductor having a larger one of the first width W1 and the second width W2 (the first conductor 30 in the present embodiment).

The first width W1 is larger than the second width W2. A ratio W1/W2 of the first width W1 to the second width W2 is not particularly limited, and is 1<W1/W2≤4, 1<W1/W2≤ 2, or 2≤W1/W2≤3. In this case, an inductance property and/or a DC superimposition property of the coil device 1 are improved.

The second mounting portion 42a is continuous with one end of the second body portion 41 in the axial direction, and the second mounting portion 42b is continuous with the other end of the second body portion 41 in the axial direction. In FIG. 4, a boundary between the second body portion 41 and the second mounting portion 42a and a boundary between the second body portion 41 and the second mounting portion 42b are indicated by one-dot chain lines. A shape of the second mounting portion 42a is the same as a shape of the second mounting portion 42b, but may be different.

The second mounting portions 42a and 42b each have a bent shape. The second mounting portions 42a and 42b are connected to the mounting substrate by solder, a conductive adhesive, or the like. Each of the second mounting portions 42a and 42b includes a curved portion 421, a leg portion 422, and an intermediate portion 423.

The curved portion 421 is continuous with the second body portion 41 and is curved in an L-shape (a C-shape) between the second body portion 41 and the intermediate portion 423. The intermediate portion 423 is positioned between the curved portion 421 and the leg portion 422. The intermediate portion 423 is orthogonal to the curved portion 421 and the leg portion 422. The intermediate portion 423 linearly extends along the Y axis so as to be separated from the leg portion 322 of the first conductor 30. The leg portion 422 linearly extends along the Z axis. A cross-sectional shape of the leg portion 422 is a rectangle, but may be a square, another polygon, or another shape.

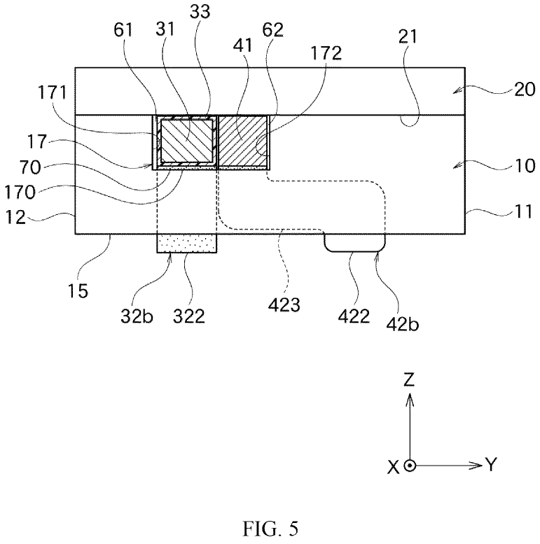

As illustrated in FIG. 3, the first body portion 31 and the second body portion 41 are disposed inside the groove 17. The first body portion 31 extends along the mounting surface 15 inside the groove 17. The second body portion 41 extends parallel to the first body portion 31 along the mounting surface 15 inside the groove 17. A depth of the groove 17 is equal to or larger than a thickness of the first body portion 31 or the second body portion 41 in the Z-axis direction so that the first body portion 31 and the second body portion 41 are not exposed from the groove 17. As illustrated in FIG. 5, the first body portion 31 is bonded to the bottom surface 170 of the groove 17 with an adhesive 70. The second body portion 41 is bonded to the bottom surface 170 with the adhesive 70. However, the upper surface of the first body portion 31 may be bonded to the contact surface 21 of the second core 20 by the adhesive 70. The upper surface of the second body portion 41 may be bonded to the contact surface 21 of the second core 20 by the adhesive 70.

The first body portion 31 and the second body portion 41 face each other along the Y axis. The side surface of the first body portion 31 (the side surface facing the second body portion 41) is in contact with the side surface of the second body portion 41 (the side surface facing the first body portion 31). Therefore, the magnetic coupling between the first body portion 31 and the second body portion 41 can be enhanced. Since the first body portion 31 has the coating (the insulating coating layer) 33, the first body portion 31 can be insulated from the second body portion 41 by the coating 33. Accordingly, a short-circuit failure can be prevented between the first body portion 31 and the second body portion 41.

A gap may be formed between the first body portion 31 and the second body portion 41. In this case, the magnetic coupling between the first body portion 31 and the second body portion 41 can be adjusted according to a size of the gap. The gap may be an air gap. Alternatively, an adhesive (for example, an adhesive containing beads) may be filled in the gap. Alternatively, a part of the first core 10 or the second core 20 may be disposed in the gap. Alternatively, a partition member (a spacer) or a film body (a film) formed of a non-conductive member such as a resin may be disposed in the gap.

Although a gap 61 is formed between the first body portion 31 and the inner wall 171 of the groove 17, the first body portion 31 may be in contact with the inner wall 171. Alternatively, the first body portion 31 and the inner wall 171 may be bonded to each other with an adhesive.

Although a gap 62 is formed between the second body portion 41 and the inner wall 172 of the groove 17, the second body portion 41 may be in contact with the inner wall 172. Alternatively, the second body portion 41 and the inner wall 172 may be bonded to each other with an adhesive.

The first body portion 31 and the second body portion 41 are accommodated in a space defined by the groove 17 so as to be sandwiched between the first core 10 and the second core 20 from above and below. The upper surface of the first body portion 31 and the contact surface 21 of the second core 20 are in contact with each other, but a gap may be formed therebetween. The upper surface of the second body portion 41 and the contact surface 21 of the second core 20 are in contact with each other, but a gap may be formed therebetween.

A height position of the first body portion 31 (including the coating 33) from the mounting surface 15 is equal to a height position of the second body portion 41 from the mounting surface 15. Therefore, the upper surface of the first body portion 31 (including the coating 33) is flush with the upper surface of the second body portion 41, and the bottom surface of the first body portion 31 is flush with the bottom surface of the second body portion 41.

However, the height position of the first body portion 31 from the mounting surface 15 may be different from the height position of the second body portion 41 from the mounting surface 15. The height position of the first body portion 31 from the mounting surface 15 may be higher than the height position of the second body portion 41 from the mounting surface 15. Alternatively, the height position of the second body portion 41 from the mounting surface 15 may be higher than the height position of the first body portion 31 from the mounting surface 15. In either case, the magnetic coupling between the first body portion 31 and the second body portion 41 can be adjusted according to the difference between the height position of the first body portion 31 from the mounting surface 15 and the height position of the second body portion 41 from the mounting surface 15.

As viewed in the X-axis direction, the leg portion 322 of the first mounting portion 32b is positioned further inward in the Y-axis direction than the second side surface 12 of the first core 10. Although not illustrated in detail, the same applies to the leg portion 322 of the first mounting portion 32a. As viewed in the X-axis direction, the leg portion 422 of the second mounting portion 42b is positioned further inward in the Y-axis direction than the first side surface 11 of the first core 10. Although not illustrated in detail, the same applies to the leg portion 422 of the second mounting portion 42a.

A lower portion of the leg portion 322 protrudes downward beyond the mounting surface 15 of the first core 10. A lower portion of the leg portion 422 protrudes downward beyond the mounting surface 15 of the first core 10. Therefore, the mounting surface 15 is positioned above bottom surfaces of the leg portions 322 and 422.

As illustrated in FIG. 1, the first mounting portions 32a and 32b are exposed from the first core 10 and the second core 20. The second mounting portions 42a and 42b are exposed from the first core 10 and the second core 20. More specifically, the curved portion 321 and the leg portion 322 illustrated in FIG. 4 are exposed from the first core 10 and the second core 20 in the recessed portion 18a or 18b illustrated in FIG. 1. The curved portion 421, the leg portion 422, and the intermediate portion 423 illustrated in FIG. 4 are exposed from the first core 10 and the second core 20 in the recessed portion 18a or 18b illustrated in FIG. 1.

The second mounting portion 42a (the intermediate portion 423) extends toward the first side surface 11 of the first core 10 so as to be separated from the first mounting portion 32a. Although not illustrated in detail, the second mounting portion 42b (the intermediate portion 423) extends toward the first side surface 11 of the first core 10 so as to be separated from the first mounting portion 32b. Therefore, the second mounting portion 42a is disposed at a position separated from the first mounting portion 32a in the Y-axis direction. As a result, when the coil device 1 is mounted on the mounting substrate, the solder, the conductive adhesive, or the like is less likely to adhere across the first mounting portion 32a and the second mounting portion 42a. Accordingly, occurrence of the short-circuit failure can be prevented between the first conductor 30 and the second conductor 40.

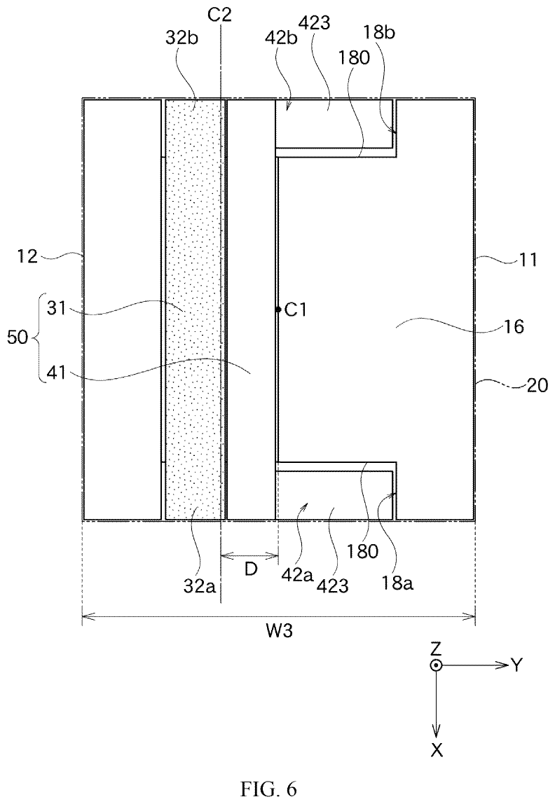

The first mounting portions 32a and 32b are disposed on both sides of the first core 10 in the X-axis direction so as to sandwich the first core 10 from both sides in the X-axis direction. As illustrated in FIG. 6, the second mounting portions 42a and 42b are disposed on both sides of the first core 10 in the X-axis direction so as to sandwich the first core 10 from both sides in the X-axis direction.

The first mounting portion 32a and the second mounting portion 42a are disposed inside an outer edge of the second core 20 as viewed in the direction perpendicular to the mounting surface 15 (the Z-axis direction). The first mounting portion 32b and the second mounting portion 42b are disposed inside the outer edge of the second core 20 as viewed in the direction perpendicular to the mounting surface 15 (the Z-axis direction). The coil device 1 can be downsized by downsizing the first mounting portion 32a and the second mounting portion 42a so that the first mounting portion 32a and the second mounting portion 42a are not exposed to the outside from the outer edge of the second core 20. The inductance property of the coil device 1 can be improved by increasing a volume of the second core 20 so that the first mounting portion 32a and the second mounting portion 42a are not exposed to the outside from the outer edge of the second core 20.

The first mounting portions 32a and 32b are covered from above by the second core 20 indicated by a two-dot chain line in FIG. 6. Therefore, as viewed from above, the first mounting portions 32a and 32b are hidden by the second core 20. The second mounting portions 42a and 42b are covered from above by the second core 20 indicated by a two-dot chain line in FIG. 6. Therefore, as viewed from above, the second mounting portions 42a and 42b are hidden by the second core 20.

The first mounting portion 32a and the second mounting portion 42a are accommodated in the recess 18a. The first mounting portion 32b and the second mounting portion 42b are accommodated in the recess 18b. Therefore, the first mounting portion 32a, the first mounting portion 32b, the second mounting portion 42a, and the second mounting portion 42b are less likely to be exposed from the outer edge of the second core 20, and the coil device 1 can be downsized.

As illustrated in FIG. 6, in the direction in which the first body portion 31 and the second body portion 41 face each other (the Y-axis direction), the first body portion 31 and the second body portion 41 are integrally set to be offset to one side (the second side surface 12 side) of the first core 10 on which the first body portion 31 is positioned. The direction in which the first body portion 31 and the second body portion 41 are offset is the side on which the first body portion 31 is disposed, in other words, the side opposite to the side on which the second body portion 41 is disposed. In the present embodiment, both the first body portion 31 and the second body portion 41 are offset to one side of the first core 10. The first body portion 31 and the second body portion 41 are offset to one side (a Y axis negative direction side) of the second core 20. The first mounting portions 32a and 32b are offset to one side of the first core 10 and the second core 20.

In the direction in which the first body portion 31 and the second body portion 41 face each other (the Y-axis direction), the first body portion 31 and the second body portion 41 are positioned on one side (the second side surface 12 side) of the first core 10 with respect to a center C1 of the first core 10. In the present embodiment, in the Y-axis direction, the entire first body portion 31 is positioned on the one side of the first core 10 with respect to the center C1 of the first core 10. In the Y-axis direction, the entire second body portion 41 is positioned on the one side of the first core 10 with respect to the center C1 of the first core 10. However, in the Y-axis direction, a part of the second body portion 41 may be positioned on the other side (the first side surface 11 side) of the first core 10 with respect to the center C1 of the first core 10.

A position of the center C1 of the first core 10 is equal to a position of a center of the second core 20. Here, a concept of “equal” includes not only a state in which the positions thereof strictly coincide with each other but also a state in which the positions thereof are deviated by several percent (for example, 5%) or less in the Y-axis direction and/or the X-axis direction.

The first body portion 31 and the second body portion 41 constitute a magnetic coupling portion 50 that is magnetically coupled to each other. The magnetic coupling portion 50 is a virtual structure in which the first body portion 31 and the second body portion 41 are regarded as one configuration. The magnetic coupling between the first body portion 31 and the second body portion 41 can be adjusted according to a distance along the Y axis between the first body portion 31 and the second body portion 41.

A central axis C2 of the magnetic coupling portion 50 is separated from the center C1 of the first core 10 by a distance D in the Y-axis direction. A ratio of D/W3 of the distance D between the central axis C2 of the magnetic coupling portion 50 and the center C1 of the first core 10 to a width W3 of the first core 10 or the second core 20 in the Y-axis direction is not particularly limited, and is 1/10≤D/W3≤⅓ or ⅛≤D/W3≤¼.

As described above, in the coil device 1 according to the present embodiment, the first conductor 30 is formed of a wire, and the second conductor 40 is formed of a conductor plate. Therefore, for the first conductor 30, there is no need to perform processes such as punching or bending the conductor plate. Accordingly, the coil device 1 can be easily manufactured and the cost can be reduced.

In addition, in the direction in which the first body portion 31 and the second body portion 41 face each other (the Y-axis direction), the first body portion 31 and the second body portion 41 (the magnetic coupling portion 50) are offset to the second side surface 12 side of the first core 10. Therefore, a space corresponding to an offset amount of the first body portion 31 and the second body portion 41 is formed on the first side surface 11 side of the first core 10. By using this space, a part of the second conductor 40 (in the present embodiment, the second mounting portions 42a and 42b) is disposed to be separated from the first conductor 30. Accordingly, occurrence of the short-circuit failure can be prevented between the first conductor 30 and the second conductor 40 (particularly, between the second mounting portions 42a and 42b).

On the first side surface 11 side of the first core 10, a volume of the first core 10 is increased according to the offset amount of the first body portion 31 and the second body portion 41 (the magnetic coupling portion 50). Therefore, the inductance property and/or the DC superimposition property of the coil device 1 are improved.

In the direction in which the first body portion 31 and the second body portion 41 face each other (the Y-axis direction), the first body portion 31 and the second body portion 41 (the magnetic coupling portion 50) are positioned on the second side surface 12 side of the first core 10 with respect to the center C1 of the first core 10. Therefore, a space for disposing a part of the second conductor 40 (in the present embodiment, the second mounting portions 42a and 42b) is formed on the first side surface 11 side of the center C1 of the first core 10. In this space, a part of the second conductor 40 (in the present embodiment, the second mounting portions 42a and 42b) is disposed to be separated from the first conductor 30. Accordingly, occurrence of a short-circuit failure can be effectively prevented between the first conductor 30 and the second conductor 40 (particularly, the second mounting portions 42a and 42b).

As illustrated in FIG. 4, the second width W2 of the second body portion 41 in the Y-axis direction is narrower than the first width W1 of the first body portion 31 in the Y-axis direction. Therefore, as compared with a case in which the first width W1 and the second width W2 are equal to each other, a larger space (a space corresponding to the difference between the first width W1 and the second width W2) for disposing the first core 10 is formed around the second body portion 41 illustrated in FIG. 6. Accordingly, the volume of the first core 10 is increased around the second body portion 41, and the inductance property and/or the DC superimposition property of the coil device 1 are improved.

Next, a method for manufacturing the coil device 1 will be described. First, the first core 10, the second core 20, the first conductor 30, and the second conductor 40 illustrated in FIG. 3 are prepared. Next, the bottom surface of the first body portion 31 illustrated in FIG. 3 is bonded to the bottom surface 170 of the groove 17 illustrated in FIG. 2 by an adhesive, and the bottom surface of the second body portion 41 is bonded thereto. At this time, as illustrated in FIG. 6, the first body portion 31 and the second body portion 41 are brought into close contact with each other so that the first body portion 31 and the second body portion 41 are in contact with each other. The first mounting portion 32a and the second mounting portion 42a are disposed inside the recess 18a, and the first mounting portion 32b and the second mounting portion 42b are disposed inside the recess 18b. Next, the contact surface 21 of the second core 20 illustrated in FIG. 3 is bonded to the mounting facing surface 16 of the first core 10 by an adhesive. As described above, the coil device 1 illustrated in FIG. 1 can be manufactured.

The present disclosure is not limited to the above embodiment, and various modifications can be made within the scope of the present disclosure.

For example, as illustrated in FIG. 6, in the above embodiment, the second body portion 41 extends linearly along the X axis, but may be bent or curved. For example, the second body portion 41 may be bent or curved so as to be separated from the first body portion 31. In this case, a gap is formed between the first body portion 31 and the second body portion 41, and the magnetic coupling between the first body portion 31 and the second body portion 41 can be lowered.

In the above embodiment, an application example of the present disclosure to the coupling inductor has been described, but the present disclosure may be applied to other electronic components.

As illustrated in FIG. 3, the core according to the above embodiment is constituted by two cores of the first core 10 and the second core 20, but the core may be constituted by one core. Such a core can be formed by, for example, (1) placing the first conductor 30 and the second conductor 40 in a press mold, (2) filling a core material for the core in the press mold, and (3) compressing and curing the core material.

As illustrated in FIG. 3, in the above embodiment, the groove 17 for accommodating the first body portion 31 and the second body portion 41 is formed in the first core 10. However, the groove for accommodating the first body portion 31 and the second body portion 41 may be formed in the second core 20.

### REFERENCE SIGNS LIST

1 coil device
10 first core
11 first side surface
12 second side surface
13 third side surface
14 fourth side surface
15 mounting surface
16 mounting facing surface
17 groove
170 bottom surface
171, 172 inner wall
18a, 18b recess
180 lateral bottom surface
20 second core
21 contact surface
30 first conductor
31 first body portion
32a, 32b first mounting portion
321 curved portion
322 leg portion
33 coating
40 second conductor
41 second body portion
42a, 42b second mounting portion
421 curved portion
422 leg portion
423 intermediate portion
50 magnetic coupling portion
61, 62 gap
70 adhesive

What is claimed is:

1. A coil device, comprising: a core having a mounting surface;
a first conductor formed of a wire; and
a second conductor formed of a conductor plate, wherein
the first conductor includes a first body portion extending along the mounting surface inside the core,
the second conductor includes a second body portion extending along the mounting surface inside the core and facing the first body portion, and
in a direction in which the first body portion and the second body portion face each other, the first body portion is positioned on one side of the core, and the first body portion and the second body portion are offset to the one side of the core on which the first body portion is positioned.

2. The coil device according to claim 1, wherein
the first body portion and the second body portion are positioned on one side of the core with respect to a center of the core in the direction in which the first body portion and the second body portion face each other.

3. The coil device according to claim 1, wherein
the first conductor includes a first mounting portion exposed from the core,
the second conductor includes a second mounting portion exposed from the core, and
the second mounting portion extends to the other side of the core so as to be separated from the first mounting portion.

4. The coil device according to claim 3, wherein
the first mounting portion and the second mounting portion are disposed inside an outer edge of the core as viewed in a direction perpendicular to the mounting surface.

5. The coil device according to claim 4, wherein
the core has a side surface perpendicular to the mounting surface and a recess formed in the side surface, and
the first mounting portion and the second mounting portion are accommodated in the recess.

6. The coil device according to claim 1, wherein
a first width of the first body portion is different from a second width of the second body portion in the direction in which the first body portion and the second body portion face each other.

7. The coil device according to claim 6, wherein
the first width is larger than the second width.

8. The coil device according to claim 1, wherein
a height position of the first body portion from the mounting surface is different from a height position of the second body portion from the mounting surface.

9. The coil device according to claim 1, wherein
the first body portion is in contact with the second body portion.

10. The coil device according to claim 1, wherein
the second conductor includes a plating layer formed on at least a part of the second conductor.

11. The coil device according to claim 1, wherein
the first conductor includes an insulating coating layer formed on at least a part of the first conductor.
